(19) United States
(12) Patent Application Publication
(10) Pub. No.: US 2009/0217649 A1
(43) Pub. Date: Sep. 3, 2009

(54) EXHAUST SYSTEM FOR A MOTOR VEHICLE AND PROCESS FOR REGENERATING A PARTICULATE FILTER IN AN AUTOMOTIVE EXHAUST SYSTEM

(76) Inventors: Kathrin Bremser, Lamerdingen (DE); Marco Ranalli, Augsburg (DE); Jürgen Klement, Asbach-Bäumenheim (DE); Wolfgang Hahnl, Grimma (DE)

Correspondence Address: CARLSON, GASKEY & OLDS, P.C., 400 WEST MAPLE ROAD, SUITE 350, BIRMINGHAM, MI, 48009, US

(21) Appl. No.: 12/159,123

(22) PCT Filed: Nov. 30, 2006
(86) PCT No.: PCT/EP2006/011503

§ 371 Date: Sep. 9, 2008

(30) Foreign Application Priority Data
Dec. 29, 2005 (DE) 10 2005 062 924.5

(51) Int. Cl. F01N 3/023; F01N 3/20; B01J 38/30; F01N 3/10; F01N 3/033

(52) U.S. Cl. 60/295; 422/173; 502/41; 60/303; 60/297

(57) ABSTRACT

An exhaust system for a motor vehicle comprises a particulate filter, upstream of which an oxidation catalyst is provided, and a regeneration device for the particulate filter. The regeneration device includes an evaporation unit for introducing a vapour generated from an oxidizable fluid into the exhaust gas stream before the oxidation catalyst. The evaporation unit includes a heating element arranged in a housing and a fluid supply with a controllable fluid pump. A control device controls the fluid pump. This invention furthermore relates to a process for regenerating a particulate filter.

### RELATED APPLICATIONS

This application is a U.S. National Phase application of PCT Application No. PCT/EP2006/011503 filed Nov. 30, 2006 which claims priority to German Application No. 10 2005 062 924.5 filed Dec. 29, 2005.

### TECHNICAL FIELD

This invention relates to an exhaust system for a motor vehicle with a particulate filter. Furthermore, this invention relates to a process for regenerating a particulate filter in an automotive exhaust system.

### BACKGROUND OF THE INVENTION

To comply with environmental regulations, the exhaust gases of motor vehicles driven by internal combustion engines must be subjected to cleaning. For reducing the particulate emissions of the exhaust gases of motor vehicles, which are driven by a Diesel engine or a lean-burning gasoline engine, suitable particulate filters are used. Such particulate filters must be regenerated from time to time by burning off the particulates accumulated on the filter surface. For this purpose, a burner is arranged upstream of the particulate filter for example, to generate the heat required for burning off by combustion of an air-fuel mixture. For igniting the air-fuel mixture, a glow plug can be used such as that known from DE 298 02 226 U1. In connection with a burner, it is also known from DE 42 42 991 A1 to use a glow plug for introducing energy into the liquid fuel.

Another known arrangement for regenerating a particulate filter disposes an oxidation catalyst upstream of the particulate filter, which generates the heat required for burning off the soot particulates by oxidizing an oxidizable substance present in the exhaust-gas stream. From DE 102 56 769 B4, for instance, a system is known, in which upstream of the oxidation catalyst an evaporation unit is disposed, in which the fuel is evaporated and introduced into the exhaust-gas stream.

In practice, however, the systems known from the prior art involve numerous difficulties, which are due to a multitude of partly contradictory system requirements.

For instance, the time of regeneration depends on the loading condition, i.e. the “degree of filling” of the particulate filter. If this time is chosen too early, not enough soot is present to perform a stable regeneration. If it is chosen too late, however, the particulate filter is clogged, or the combustion of soot produces very high temperatures in the particulate filter, which can lead to its destruction.

If the exhaust gas temperature before the oxidation catalyst is too low, the oxidizable vapour supplied cannot be converted thermally. It is condensed in the oxidation catalyst and leads to its destruction.

If too much fluid is introduced into the evaporation unit, and if the fluid cannot evaporate sufficiently, it enters the exhaust system in the liquid condition. If the fluid entering the exhaust system cannot sufficiently be reevaporated by the hot exhaust gases and the hot tube walls, the downstream oxidation catalyst is damaged.

If too much fluid is evaporated, too much energy is generated by the catalyst and the particulate filter is damaged by excessive regeneration temperatures. At the same time, fluid consumption is rising unnecessarily.

If too little fluid is introduced into the evaporator, the catalyst cannot produce the temperature increase of the exhaust gas necessary for the regeneration of the particulate filter. There is no regeneration of the particulate filter, but an unnecessary fluid consumption.

If a heating element provided in the evaporation unit is switched on too soon, power consumption rises unnecessarily. On the other hand, if the heating element is put into operation too late, the oxidizable fluid is not sufficiently evaporated, partly reaches the exhaust system in the liquid condition, and damages the oxidation catalyst. The postheating time of the heating element also determines the proper conversion of the fluid into vapour.

In addition, there are further influential factors which depend on the operating point of the engine, a possibly present exhaust gas turbocharger, components for exhaust gas recirculation, and many more. These factors also influence the regeneration of the particulate filter and must be considered by the regeneration system.

It is the object underlying the invention to solve the described technical contradictions and make the regeneration of a particulate filter safe and suitable for series production.

### SUMMARY OF THE INVENTION

In accordance with the invention, there is provided an exhaust system for a motor vehicle, comprising a particulate filter upstream of which an oxidation catalyst is provided, and a regeneration device for the particulate filter. The regeneration device includes an evaporation unit for introducing a vapour generated from an oxidizable fluid into the exhaust gas stream before the oxidation catalyst. The evaporation unit includes a heating element arranged in a housing and a fluid supply with a controllable fluid pump. A control device is provided for controlling the fluid pump. By suitable control of the fluid pump, in particular in dependence on the temperatures existing at various points of the exhaust system, the difficulties known from the prior art can be solved satisfactorily.

In particular, the oxidizable fluid can be the same fuel which is also supplied to the internal combustion engine, whereby an additional fluid supply can be omitted. The fuel simply is withdrawn from the fuel tank of the vehicle or from the fuel return conduit.

The heating element advantageously is a glow plug, i.e. a mass-produced article available at low cost.

In accordance with a preferred embodiment, the control device is connected with the engine control or integrated in the same. In particular, the control device utilizes data present in the engine control in order to consider the same in the control of the fluid pump.

The object of the invention is also solved by a process for regenerating a particulate filter with upstream oxidation catalyst in an automotive exhaust system with a regeneration device, which comprises an evaporation unit for introducing a vapour generated from an oxidizable fluid into the exhaust gas stream before the oxidation catalyst. The evaporation unit includes a heating element arranged in a housing and a fluid supply with a controllable fluid pump. The process includes the following steps, which are performed periodically: The regeneration process first is started in dependence on the back pressure of the particulate filter or on the time elapsed since the last regeneration process (step a). Subsequently, the heating element is switched on, as soon as the temperature upstream of the oxidation catalyst exceeds a specified minimum value (step b). After waiting a specified preheating time for the heating element (step c), the fluid pump is switched on with a specified delivery rate (step d), and a specified pumping period is allowed to pass (step e). Subsequently, the fluid pump is operated according to specified parameters, if downstream of the oxidation catalyst a higher temperature exists than upstream of the oxidation catalyst (step f). Thereupon, a likewise specified regeneration period is allowed to pass, which starts as soon as the temperature downstream of the oxidation catalyst has exceeded a specified minimum value, wherein during the regeneration period the temperature downstream of the particulate filter is checked periodically and possibly controlled at least by influencing the introduced fuel quantity (step g). After the regeneration period has passed, the fluid pump is switched off (step h), a specified postheating time of the heating element is allowed to pass (step i), and finally the heating element is switched off (step j). Subsequently, the process starts again. Thus, the process of the invention not only makes sure that the regeneration is started at the proper time (step a) and the exhaust gas temperature before the oxidation catalyst is high enough (step b), but due to the pre-heating and postheating times, also ensures a safe evaporation of the oxidizable fluid. A precisely adapted metering of fluid, which prevents the particulate filter from being damaged or even destroyed, is achieved by the temperature-dependent control (step g). Thus, the process of the invention meets all requirements mentioned above.

To prevent the system from being damaged, an error can be registered, if after waiting for the specified pumping period, the temperature downstream of the oxidation catalyst is not higher than the temperature upstream of the oxidation catalyst.

Preferably, the process proceeds to step d) after registering the error, as long as the number of registered errors does not exceed a specified maximum value.

Upon exceeding the specified maximum value for registered errors, the regeneration process should be stopped and an error signal should be issued. This can include, for instance, switching on an error signal lamp, which informs the driver of the motor vehicle that repair is necessary.

To prevent the particulate filter from being damaged by excessive regeneration temperatures, the fluid pump is switched off in connection with the temperature control during the regeneration period, as soon as the temperature downstream of the particulate filter exceeds a specified first value during the regeneration period (step g).

In accordance with a first embodiment of the invention, operation of the fluid pump according to specified parameters is resumed after switching off the fluid pump during the regeneration period, as long as the specified regeneration period is not terminated and as soon as one of the following conditions occurs, which are checked periodically in the indicated order:

the temperature downstream of the particulate filter lies below a specified second value,

the temperature downstream of the oxidation catalyst falls below a specified minimum value,

the temperature downstream of the particulate filter no longer lies above the specified first value.

In this way, it is prevented that an insufficient fluid quantity is supplied to the exhaust gas stream during the regeneration period, which would impair the regeneration.

In accordance with a second embodiment of the invention, a proportional-integral-derivative (PID) controller is used for controlling the temperature during the regeneration period (step g), if the temperature downstream of the oxidation catalyst lies within a specified control interval. Such PID controller offers the advantage of a faster temperature control than a control by merely varying the introduced fuel quantity. As a control parameter, the temperature downstream of the oxidation catalyst, i.e directly upstream of the particulate filter, is used.

To prevent an “overshooting” of the PID controller caused by system-related oscillation processes, it should be checked after each control operation of the PID controller whether the temperature downstream of the oxidation catalyst still lies within the specified control interval.

In the variant with the PID control, after switching off the fluid pump during the regeneration period, the operation of the fluid pump according to specified parameters is resumed, if the temperature downstream of the particulate filter lies below a specified second value and the temperature downstream of the oxidation catalyst lies outside the specified control interval for the PID controller. This is of course only applicable for the time period of regeneration.

In addition, the current flowing through the heating element can be monitored during operation of the heating element.

It should be appreciated that the regeneration process only is started with running engine.

### BRIEF DESCRIPTION OF THE DRAWINGS

Further features and advantages of the invention can be taken from the following description of several preferred embodiments with reference to the attached drawing, in which:

FIG. 1 shows a schematic representation of an exhaust system in accordance with the invention;

FIG. 2a shows a flow diagram of a first part of the process of the invention;

FIG. 2b shows a flow diagram of a second part of the process of the invention directly adjoining the first part in accordance with a first variant;

FIG. 2c shows a flow diagram of a third part of the process of the invention, which directly adjoins the second part; and

FIG. 3 shows a flow diagram of an alternative second part of the process of the invention, which can replace the part shown in FIG. 2b.

### DETAILED DESCRIPTION OF THE PREFERRED EMBODIMENT

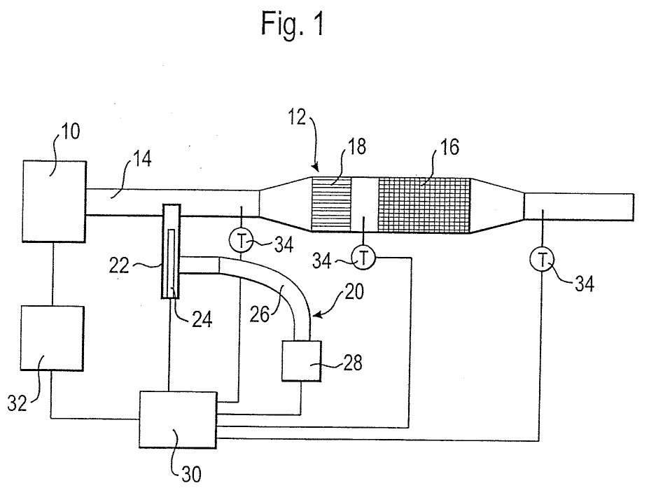

FIG. 1 schematically shows an internal combustion engine 10 of a motor vehicle and a downstream exhaust system 12. In particular, the combustion engine 10 is a Diesel engine. The exhaust system 12 includes an exhaust gas conduit 14, which leads to a particulate filter 16 with upstream oxidation catalyst 18. Upstream of the oxidation catalyst 18, an evaporation unit 20 is provided, which includes a heating element 24, here in the form of a glow plug, which is arranged in a housing 22, and a fluid supply 26 with a controllable fluid pump 28. In particular, the fluid supply 26 is a fuel conduit, and the fluid pump 28 is a fuel pump with a connection to the fuel tank of the vehicle (not shown). The fuel can also be taken from the fuel return conduit; in this case, the fuel already is preheated.

The evaporation unit 20 forms part of a regeneration device for the particulate filter 16, which furthermore comprises a control device 30 for controlling the fluid pump 28. The heating element 24 is connected with the control device 30 and can be driven by the same. The control device 30 in turn is connected with the engine control 32 or, alternatively, directly integrated in the same.

The exhaust system 12 furthermore includes a plurality of temperature sensors 34, which likewise are connected with the control device 30 and determine the temperature before and after the oxidation catalyst 18 and the temperature after the particulate filter 16. Furthermore, pressure sensors (not shown) can be provided to determine the back pressure of the particulate filter 16.

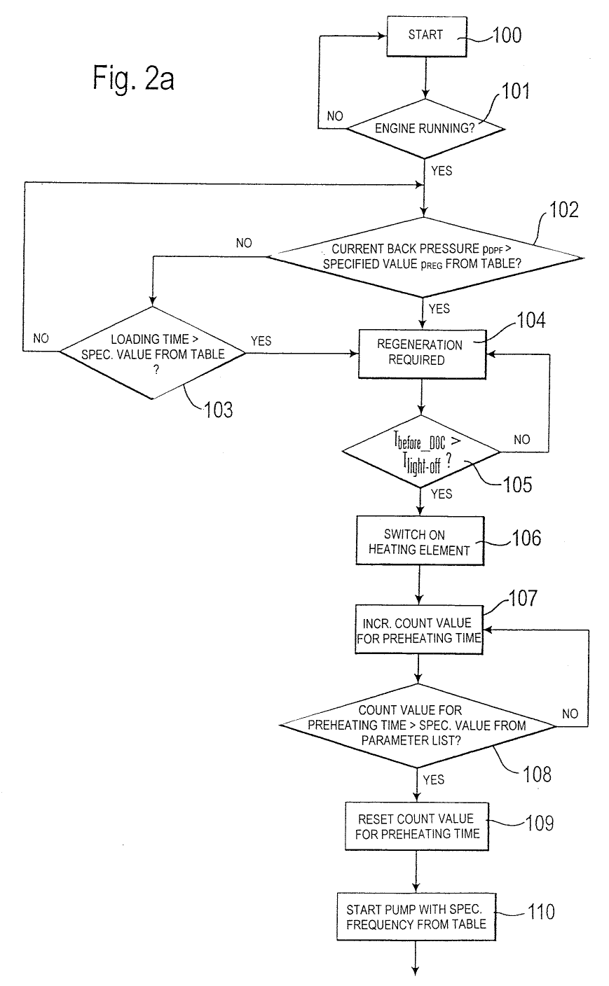

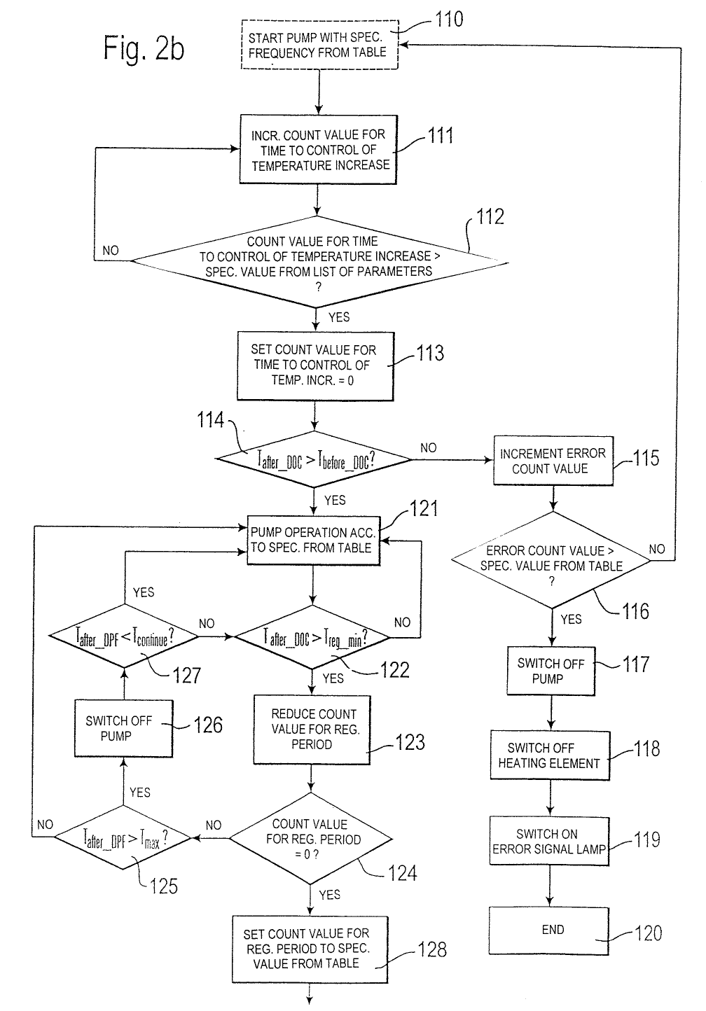

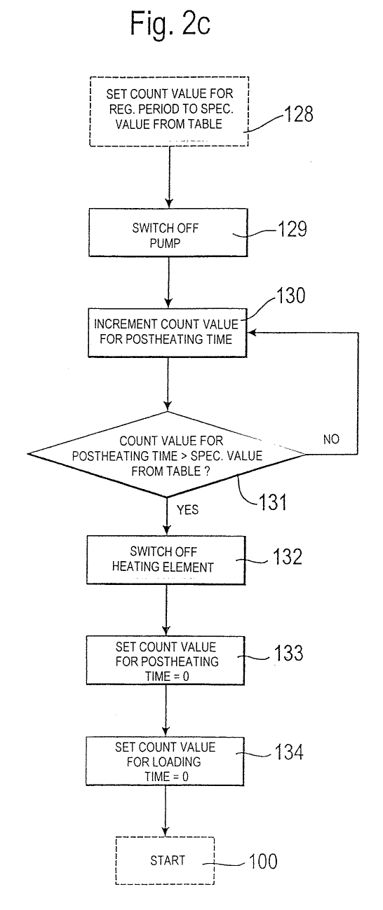

For regenerating the particulate filter 16, a process is employed, which will be described below with reference to FIGS. 2a to 2c.

After the start of the process (step 100), it is first checked in step 101 whether the internal combustion engine 10 is running. If this is not the case, there is no further activity; the process starts again. If the engine is running, the current back pressure value p_{DPF} of the particulate filter 16 is determined in the next step 102 by using the pressure sensors, and it is checked whether this current back pressure value exceeds a specified limit value p_{reg} for the regeneration. If this is the case, a regeneration requirement is detected (step 104). However, if the current back pressure value p_{DPF} lies below the specified limit value p_{reg}, it is checked in step 103 whether the time elapsed since the last regeneration process (also referred to as “loading time” of the particulate filter) exceeds a specified limit value. If this is the case, the process likewise continues with step 104, otherwise the process goes back to step 102.

After the regeneration requirement has been detected, it is checked whether the temperature upstream of the oxidation catalyst 18, T_{before}_{_{—}}_{DOC}, exceeds a specified minimum value T_{light-off} (step 105). If this is the case, the heating element (the glow plug in the present embodiment) is switched on in the next step 106. If the temperature before the oxidation catalyst lies below the minimum value T_{light-off}, the process goes back from step 105 to step 104.

After switching on the heating element 24, a specified preheating time is allowed to pass, in that in step 107 a count value for the preheating time first is incremented, and in step 108 it is checked whether the value of the counter for the preheating time exceeds a specified value. If this is not the case, steps 107 and 108 are repeated, until the value for the preheating time finally exceeds the specified value. Subsequently, the counter for the preheating time is reset (step 109), and the fluid pump 28 is switched on with a specified delivery rate (step 110). The delivery rate can for instance be adjusted via a pumping frequency.

After switching on the fluid pump (see FIG. 2b), a specified pumping period is allowed to pass, in that a count value for the time to the measurement of a temperature increase after the oxidation catalyst 18 (alternatively also after the particulate filter 16) is incremented (step 111), and subsequently it is checked whether the count value for the time to the temperature measurement already exceeds a specified value (step 112). Steps 111 and 112 also are repeated, until the specified pumping period, which corresponds to the specified waiting period to the temperature measurement, is achieved.

Subsequently, the count value for the time to the temperature measurement is set to zero (step 113), and it is checked whether the temperature after the oxidation catalyst 18, T_{after}_{_{—}}_{DOC}, is greater than the temperature before the oxidation catalyst, T_{before}_{_{—}}_{DOC}, as expected (step 114). If this is the case, the fluid pump 28 is operated according to specified parameters (step 120).

Otherwise, an error is registered, in that the value of an error counter is incremented by 1 (step 115), whereupon it is checked whether the error count value already is greater than a specified maximum value for registered errors (step 116). If this is not the case, the process is resumed with step 110, namely switching on the pump with a specified delivery rate. However, if the error count value already exceeds the specified maximum value, the regeneration process is stopped, in that first the fluid pump (step 117) and then the heating element 24 is switched off (step 118). To inform the owner of the vehicle that repair or a system check is necessary, an error signal lamp finally is switched on (step 119), and the regeneration process ends with step 120, so as not to be resumed again until after a possible repair.

If, as expected, a higher temperature exists downstream of the oxidation catalyst 18 than upstream of the oxidation catalyst, the fluid pump 28 is operated according to specified parameters (step 121), as already mentioned. Subsequently, it is checked whether the temperature after the oxidation catalyst 18, T_{after}_{_{—}}_{DOC}, has exceeded a specified minimum value T_{reg}_{_{—}}ₘᵢₙ necessary for a successful regeneration (step 122). If this is the case, a count value for the regeneration period, which has a specified positive value (i.e. different from zero), is reduced (step 123). In the following step 124 it is checked whether the count value for the regeneration period is zero, i.e. the specified regeneration period has already been reached. However, if the temperature downstream of the oxidation catalyst 18 has not yet reached the specified minimum value T_{reg}_{_{—}}ₘᵢₙ, the fluid pump 28 is operated further, wherein the parameters for pump operation can be varied.

As long as the end of the regeneration period has not yet been reached, it is checked subsequent to step 124 whether the temperature downstream of the particulate filter, T_{after}_{_{—}}_{DPF}, exceeds a specified first value Tₘₐₓ. If this is not the case, i.e. if there is no risk that the particulate filter 16 becomes too hot, the process will thereupon be performed starting with step 121, until the regeneration period is terminated, which is detected in step 124.

On the other hand, if the temperature after the particulate filter 16 exceeds the specified temperature Tₘₐₓ, the fluid pump 28 is switched off (step 126), in order to thus decrease the temperature existing after the particulate filter 16 (and also in the same). Subsequently, it is checked in step 127 whether the temperature after the particulate filter, T_{after}_{_{—}}_{DPF}, lies below a specified second value T_{continue}, up to which a further supply of oxidizable fluid to the evaporation unit 20 is not critical. Thus, if the temperature after the particulate filter lies below T_{continue}, the operation of the fluid pump 28 is resumed according to specified parameters, and the regeneration process is continued with step 121, until the regeneration period has elapsed (step 124). Steps 121 to 124 and possibly also 125 to 127 are performed repeatedly.

If the temperature after the particulate filter does not lie below the specified second value T_{continue}, the process proceeds from step 127 to step 122, in which the temperature after the oxidation catalyst 18 is compared with the minimum value T_{reg}_{_{—}}ₘᵢₙ required for regeneration, without the operation of the pump being resumed. In this case, pump operation thus is not resumed before the time when in the repeated process step 125 the temperature after the particulate filter, T_{after}_{_{—}}_{PDF}, has decreased below the first specified value Tₘₐₓ, whereupon the process goes to step 121.

As soon it is detected in step 124 that the specified regeneration period is terminated, the count value for the regeneration period is set to a specified value, which is stored in the control device 30 (step 128), and the fluid pump 28 is switched off (step 129, see FIG. 2c). Subsequently, a specified postheating time of the heating element 24 is allowed to pass, in that in process step 130 a count value for the postheating time is incremented and subsequently compared with a specified value (step 131). As long as the count value for the postheating time does not exceed the specified value, steps 130 and 131 are performed again and again. As soon as the specified postheating time has been reached, the heating element 24, here the glow plug, is switched off (step 132), and the count value for the postheating time is set to zero (step 133).

Subsequently, the counter for the time elapsed since the last regeneration process (also referred to as “loading time” of the particulate filter 16) is set back to zero (step 134), and the process goes back to the start (step 100). In this way, a discontinuous, periodic regeneration of the particulate filter 16 is achieved.

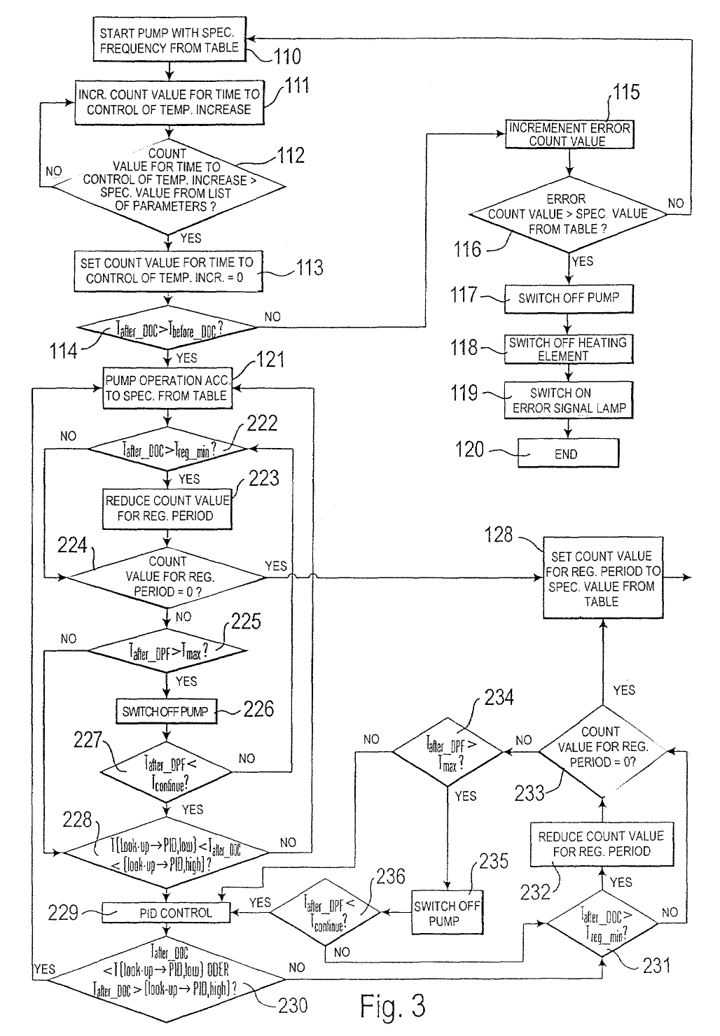

FIG. 3 shows the middle part of a process for regenerating the particulate filter 16 in accordance with a second embodiment of the invention, which differs from the above-described process of FIGS. 2a to 2c merely in the type of temperature control during the regeneration period. The first part of the process not shown in FIG. 3 corresponds to FIG. 2a, the last part corresponds to FIG. 2c. Thus, the process part as shown in FIG. 3 merely replaces the part as shown in FIG. 2b.

The process in accordance with the second variant including step 121 proceeds analogous to the process described above. In the succeeding step 222, it is likewise checked whether the temperature after the oxidation catalyst 18 exceeds the specified minimum value for regeneration, T_{reg}_{_{—}}ₘᵢₙ. If this is the case, the count value for the regeneration period is reduced in the next step 223, and it is subsequently (step 224) checked whether the count value for the regeneration period is zero, i.e. the regeneration period already is terminated.

In contrast to the process in accordance with the first embodiment, step 224 of the process is performed, if the temperature after the oxidation catalyst does not reach the minimum temperature T_{reg}_{_{—}}ₘᵢₙ. As long as the specified regeneration period is not terminated, it is subsequently checked whether the temperature after the particulate filter 16 exceeds the specified first value Tₘₐₓ. If this is the case, the fluid pump 28 is switched off again (step 226), and it is subsequently checked whether the temperature after the particulate filter lies below a second value T_{continue} (step 227). If this is the case, or if it is detected in step 225 that the temperature after the particulate filter does not exceed the specified first temperature value Tₘₐₓ, it is subsequently checked in step 228 whether the temperature downstream of the oxidation catalyst 18 lies within a specified control interval, namely between the specified values T (look-up→PID, low) and T (look-up→PID, high). However, if the temperature after the particulate filter is not smaller than T_{continue}, the process is continued with step 222.

If the temperature after the oxidation catalyst lies within the specified control interval, a PID controller, which can be integrated in the control device 30, is used for controlling the temperature (step 229), so as to bring the same to an optimum temperature value for regeneration. The PID controller offers the advantage that the desired temperature can be adjusted much faster than would be possible by merely switching on and off the fluid pump 28. After the control operation 229, it is checked in step 230 whether the temperature downstream of the oxidation catalyst 18 now possibly lies outside the specified control interval, i.e. whether the PID controller has controlled too much in the one or other direction. If this is the case, the process goes back to step 121; however, if the temperature after the oxidation catalyst still lies within the control interval, the process continues with step 231, which corresponds to step 222, and checks whether the temperature after the oxidation catalyst 18 lies above the specified minimum temperature for regeneration T_{reg}_{_{—}}ₘᵢₙ. If this is the case, the count value for the regeneration period is reduced, and it is subsequently checked whether this count value is zero (steps 232, 233, which correspond to steps 223 and 224). However, if the temperature after the oxidation catalyst lies below the required minimum temperature for regeneration, T_{reg}_{_{—}}ₘᵢₙ, the process directly proceeds from step 231 to step 233 without reducing the count value for the regeneration period.

As long as the regeneration period is not terminated, the temperature after the particulate filter 16 subsequently is checked, as to whether it exceeds the specified first temperature value Tₘₐₓ (step 234). If this is not the case, the process continues with step 229, namely the control operation by the PID controller; otherwise, the fluid pump 28 is switched off (step 235), and it is checked whether the temperature after the particulate filter 16 lies below the second specified value T_{continue} (step 236). If the temperature after the particulate filter 16 is smaller than T_{continue}, there is likewise effected a control operation by the PID controller (step 229); however, if the temperature after the particulate filter 16 exceeds the temperature T_{continue}, the process continues with step 231, i.e. checks whether the temperature after the oxidation catalyst exceeds the specified minimum value T_{reg}_{_{—}}ₘᵢₙ.

Thus, in the process in accordance with the second embodiment, the fluid pump 28 likewise is always switched off, as soon as the temperature downstream of the particulate filter 16 exceeds a specified first value Tₘₐₓ during the regeneration period. In contrast to the process in accordance with the first embodiment, the operation of the fluid pump 28 subsequently is resumed according to specified parameters, if the temperature downstream of the particulate filter 16 lies below the specified second value T_{continue} and the temperature downstream of the oxidation catalyst 18 lies outside the specified control interval for the PID controller.

Upon termination of the regeneration period, which is detected in step 233 or 224, the counter for the regeneration period is set equal to a value specified in the control device (step 128), and the process for regeneration is terminated, as described already with reference to FIG. 2c.

Finally, it should be noted that none of the specified values stored in the control device 30 must be universally applicable individual values, but for each specified value a list of values can exist, from which depending on the current operating condition (current data from the engine control, currently existing temperatures at different points of the exhaust system 12, and further parameters such as exhaust gas mass flow, etc.) the specified value corresponding to this operating condition or most suitable for this operating condition is selected.

### LIST OF REFERENCE NUMERALS

10 internal combustion engine

12 exhaust system

14 exhaust gas conduit

16 particulate filter

18 oxidation catalyst

20 evaporation unit

22 housing

24 heating element

26 fluid supply

28 fluid pump

30 control device

32 engine control

34 temperature sensors

100-134 process steps

222-236 process steps

1. An exhaust system for a motor vehicle comprising:
a particulate filter;
an oxidation catalyst provided upstream of the particulate filter; and
a regeneration device for the particulate filter, the regeneration device comprising an evaporation unit that introduces a vapour generated from an oxidizable fluid into an exhaust gas stream before the oxidation catalyst,
wherein the evaporation unit includes a heating element arranged in a housing, a fluid supply with a controllable fluid pump, and a temperature sensor arranged downstream of the particulate filter, and
wherein a control device is provided for controlling the fluid pump.

2. The exhaust system according to claim 1, wherein the oxidizable fluid is comprised of fuel which is also supplied to the internal combustion engine.

3. The exhaust system according to claim 1, wherein the heating element is a glow plug.

4. The exhaust system according to claim 1 wherein the control device is connected with an engine control or integrated in the engine control.

5. The exhaust system according to claim 1 wherein the control device also controls the heating element.

6. A process for regenerating a particulate filter with an upstream oxidation catalyst in an automotive exhaust system with a regeneration device, wherein the regeneration device comprises an evaporation unit that introduces a vapour generated from an oxidizable fluid into the exhaust gas stream before the oxidation catalyst, and wherein the evaporation unit includes a heating element arranged in a housing and a fluid supply with a controllable fluid pump,
the process comprising the following process steps, which are performed periodically:
a) starting a regeneration process in dependence on a back pressure of the particulate filter or an amount of time elapsed since the last regeneration process;
b) switching the heating element on as soon as a temperature upstream of the oxidation catalyst exceeds a specified minimum value;
c) allowing a specified preheating time for the heating element to pass;
d) switching the fluid pump on with a specified delivery rate;
e) allowing a specified pumping period to pass;
f) operating the fluid pump according to specified parameters if a higher temperature exists downstream of the oxidation catalyst than upstream of the oxidation catalyst;
g) allowing a specified regeneration period to pass, which starts as soon as the temperature downstream of the oxidation catalyst has exceeded a specified minimum value, wherein during the specified regeneration period a temperature downstream of the particulate filter is checked periodically and possibly controlled at least by influencing an introduced fluid quantity of the oxidizable fluid;
h) switching the fluid pump off;
i) allowing a specified postheating time of the heating element to pass; and
j) switching the heating element off.

7. The process according to claim 6, including registering an error if upon waiting for the specified pumping period of step e), the temperature downstream of the oxidation catalyst is not higher than the temperature upstream of the oxidation catalyst.

8. The process according to claim 7 wherein, after registering the error, the process goes to step d), as long as a number of registered errors does not exceed a specified maximum value.

9. The process according to claim 8 wherein, after exceeding the specified maximum value for registered errors, the regeneration process is stopped and an error signal is issued.

10. The process according to claim 6 including switching the fluid pump as soon as the temperature downstream of the particulate filter exceeds a specified first value during the specified regeneration period of step g).

11. The process according to claim 10 wherein, after switching off the fluid pump during the specified regeneration period, the operation of the fluid pump is resumed according to specified parameters, as long as the specified regeneration period is not terminated, and as soon as one of the following conditions occurs, which are periodically checked in the indicated order:
the temperature downstream of the particulate filter lies below a specified second value;
the temperature downstream of the oxidation catalyst falls below a specified minimum value;
the temperature downstream of the particulate filter no longer lies above the specified first value.

12. The process according to claim 6 including using a PID controller to control the temperature during the regeneration period of step g), if the temperature downstream of the oxidation catalyst lies within a specified control interval.

13. The process according to claim 12 wherein, after each control operation of the PID controller, including the step of checking whether the temperature downstream of the oxidation catalyst still lies within the specified control interval.

14. The process according to claim 12 wherein, after switching off the fluid pump during the specified regeneration period, operation of the fluid pump is resumed according to specified parameters if the temperature downstream of the particulate filter lies below a specified second value and the temperature downstream of the oxidation catalyst lies outside the specified control interval for the PID controller.

15. The process according to claim 6 including monitoring current flowing through the heating element during operation of the heating element.

16. The process according to claim 6 wherein the regeneration process only is started with a running engine.
